(19) United States
(12) Patent Application Publication
(10) Pub. No.: US 2003/0124980 A1
(43) Pub. Date: Jul. 3, 2003

(54) Analog bi-phase modulation

(76) Inventor: Joseph Alfred Webb, Canterbury (NZ)

Correspondence Address: TREXLER, BUSHNELL, GIANGIORGI,, BLACKSTONE & MARR, LTD., 105 W. ADAMS STREET, CHICAGO, IL, 60603, US

(21) Appl. No.: 10/317,322

(22) Filed: Dec. 12, 2002

(30) Foreign Application Priority Data
Dec. 12, 2001 (NZ) 516037

(51) Int. Cl. H04B 7/00

(52) U.S. Cl. 455/59; 455/205; 455/214; 455/334

(57) ABSTRACT

An analog modulation technique where the message information is contained in the timing of phase reversal zero crossings in the transmitted signal. In the preferred implementation a bias signal is added to an information signal and the composite signal hard limited to produce a square wave. The square wave is used to switch the phase of a carrier signal so that phase reversals occur in correspondence with the change in polarities of the square wave. A demodulation technique is also disclosed.

### FIELD OF THE INVENTION

This invention relates to a modulation system for improved communications and in particular an analog bi-phase modulation technique where the message information is contained in the timing of phase reversal zero crossings of the transmission signal.

### DESCRIPTION OF THE PRIOR ART

Bi-Phase Modulation (BBPM) has been used in transmission of binary (2-level) data. In this simple bi-phase method, the signal consists of only 2 designated levels, but it is not at all suitable for transmitting analog (multi-level) signals such as voice. Because this method uses only designated signal reversal with fixed timing, voice transmitted by this method produces very deleterious effects. First, (hard limited) voice is grossly distorted. Secondly, because the prior art method requires that the signal be at full amplitude at all times, gaps between words are filled with noise, making this method very difficult for the listener to endure.

Frequency modulation (FM) has well known attributes for the communication of analog signals such as voice. Whereas FM in principle is easy to understand, it is much more complex for the engineer to explain in technical terms. To the layman, the FM transmitter is simply swept back and forth in frequency in accordance with the amplitude of the signal being transmitted. However, to the engineer or statistician this simple frequency sweep involves a complex Bessel function that spreads the frequency band in a very complex manner. FM is in wide use today, especially for broadcast, because of its noise suppression characteristics, but its noise suppression characteristic comes with a significant bandwidth penalty. Wider bandwidth also invites wider bandwidth noise. Commercial FM broadcast, for example, spreads the bandwidth of the carrier by a factor of at least 5:1 compared to AM.

Because bandwidth spreading of the FM carrier signal acts to suppress noise, it is appropriate to spread the bandwidth as widely as possible, consistent within the limits of the allocated spectrum. Voice, music, and other typical analog signals however have relatively wide dynamic range, and noise suppression demands even greater bandwidth spreading. But when signal amplitude is low, there is less instantaneous noise suppression, and it is the instantaneous spreading of the spectrum that provides noise suppression.

Furthermore, greater bandwidth spreading lowers the noise suppression “threshold”, below which noise suppression breaks down entirely, and the signal becomes unusable. In other words, bandwidth spreading suppresses noise when the signal level is strong, but reduces its performance in weak signals.

Optimum noise suppression is obtainable only when the modulating signal is at full amplitude level But the dynamic range of analog signals can be very large, making it difficult or impossible to keep the signal level at full amplitude all the time. At low instantaneous signal level, noise suppression is also very low. This suggests that modulation should be at full amplitude at all times if optimum noise suppression is to be achieved. Optimum noise suppression is obtainable only if the modulating signal amplitude is always constant and always at full amplitude. This is impossible for FM signals, since wide dynamic range demands that much of the time the signal is at low levels, providing low noise suppression.

### SUMMARY OF THE INVENTION

It is an object of the present invention to provide a method of modulation and apparatus therefor suitable for analog signals which addresses the abovementioned disadvantages of the prior art.

A farther object of the invention is to provide better quality and more reliable communications through the use of a more efficient modulation and detection system.

Yet a further object of the invention is to provide quality communications while limiting the bandwidth needed to transmit the signal.

A yet still further object of the invention is to provide extended range communication using less power than that of conventional methods such as FM or AM.

Accordingly in a first aspect the invention consists in a method of modulation for a communications system wherein the transmitted information in the transmission signal is carried in the timing of the phase reversal zero crossings in the transmission signal alone.

In a second aspect the invention consists in a communication system wherein the transmitted information in the transmission signal is carried in the timing of the phase reversal zero crossings in the transmission signal alone.

In a third aspect the invention consists in a method of modulation for a transmission system comprising the steps of:

receiving an information signal;

adding a bias signal to said information signal to produce a composite signal;

hard limiting the composite signal to produce a square wave;

generating a carrier signal;

reversing the phase of said carrier signal in correspondence with the change in polarities of said square wave; and

transmitting the signal produced by said phase reversal of said carrier signal.

In a fourth aspect the invention consists in a modulator for a transmission system comprising:

an input for receiving an information signal;

a bias signal generator,

an adder circuit for adding said bias signal to said information signal to produce a composite signal;

a hard limiter which receives said composite signal to produce a square wave output;

a carrier signal generator;

an analog switch which receives said carrier signal and which is switched by the square wave output of said hard limiter;

said analog switch reversing the phase of said carrier signal in correspondence with the change in polarities of said square wave; and

an output means which receives the signal produced by said analog switch.

In a fifth aspect the invention consists in A demodulator for demodulating transmitted signals having a suppressed carrier wherein the transmitted information is carried in the timing of phase reversal zero crossings in the transmitted signal comprising:

a hard limiter which receives said transmitted signals at its input;

a multiplier which receives the output of said hard limiter at one input;

means for reconstituting said suppressed carrier from the output of said hard limiter;

the output of said means for reconstituting being supplied to the second input of said multiplier; and

a low pass filter connected to the output of said multiplier,

the information signal being available at the output of said low pass filter.

The analog bi-phase modulation (ABPM) of the present invention provides a means for assuring that the modulating signal is at fall amplitude at all times, so that it can provide optimum noise suppression. This will assure that the signal retains full dynamic range for the modulating signal while providing optimum noise suppression even at low signal levels. It is also proposed to show that full noise suppression is retained while minimizing the bandwidth of the signal to its allocated, baseband spectral range. The detection threshold of the signal is dramatically reduced by use of ABPM because ABPM gives full noise suppression, as it allows the modulating signal to be at full signal level at all times.

Optimum noise suppression is obtained only when the modulating signal is at full amplitude. Therefore, the present invention is arranged so that the signal remains at full amplitude at all times, while at the same time retaining its full dynamic range and full noise suppression. The way this is accomplished is by conditioning the signal by the use of a “bias” signal, or fixed idling frequency, that is transmitted along with the signal at all times, but can be removed from the signal once the signal has reached the receiver and been detected. The bias serves to allow the signal-plus-bias to be hard limited for a second time after detection at the receiver. Bias can then be filtered and rejected once its noise suppression job is done.

The preferred method of ABPM is to add a bias as a fixed frequency at the top frequency of the modulating signal, followed by hard limiting signal-plus-bias to get a fixed amplitude signal for modulating the carrier. The amplitude of the bias must be slightly greater than that of the modulating signal, so that the bias actually controls the limiting process. A sinusoidal bias is satisfactory, but a triangular wave bias has also been tested experimentally. The carrier is switched (modulated) by signal-plus-bias through simple carrier phase reversals. Following hard limiting and detection at the receiver, the bias frequency is removed by filtering. The bias allows the signal to be detected and filtered, and to retain full noise suppression.

The effectiveness of ABPM is due to its use of random (untimed) zero crossings. Other digital technologies use fixed (clocked) zero crossing timing. ABPM does not time the zero crossings of the carrier, but allows the carrier itself to control the timing of zero crossings. Although average zero crossings are fixed by the use of a fixed frequency bias, the exact timing of zero crossings is determined by the sum of the bias-plus-modulating signal waveforms. This is the key to the success of the ABPM method.

ABPM is a new modulation system, and it is not just another method of transmitting FM. There is no frequency sweep by this method, but only phase switching of the zero crossings as in ordinary bi-phase modulation. Unlike the case of ordinary bi-phase however, this method uses the information in the instantaneous timing of the zero crossings to provide linear analog output. Ordinary bi-phase is inherently binary, and has fixed timing of its zero crossings. The present method derives its analog integrity by using its largely untimed zero crossings as modulating information.

### BRIEF DESCRIPTION OF THE PREFERRED EMBODIMENTS

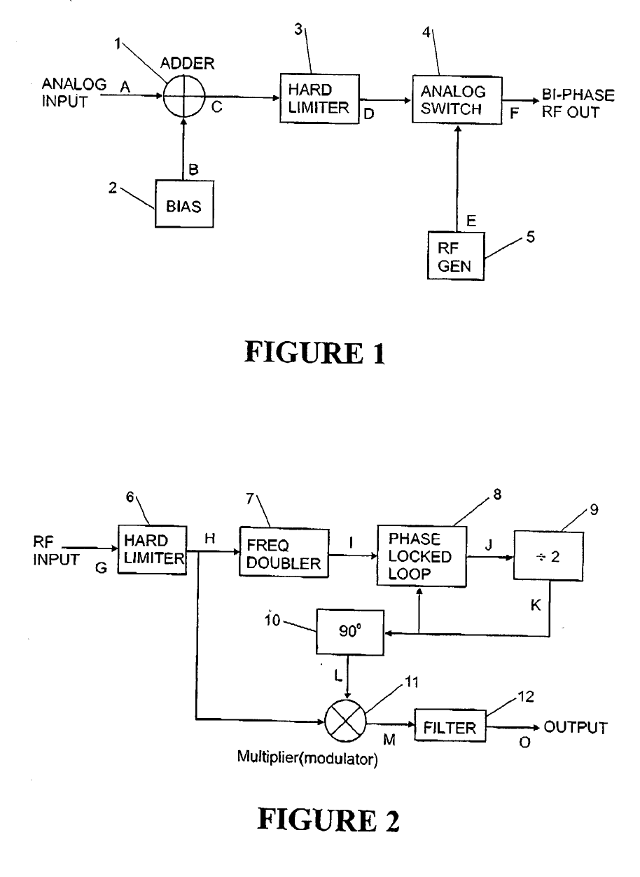

FIG. 1 shows a block diagram of an ABPM transmitter,

FIG. 2 shows a block diagram of a receiver for demodulating ABPM,

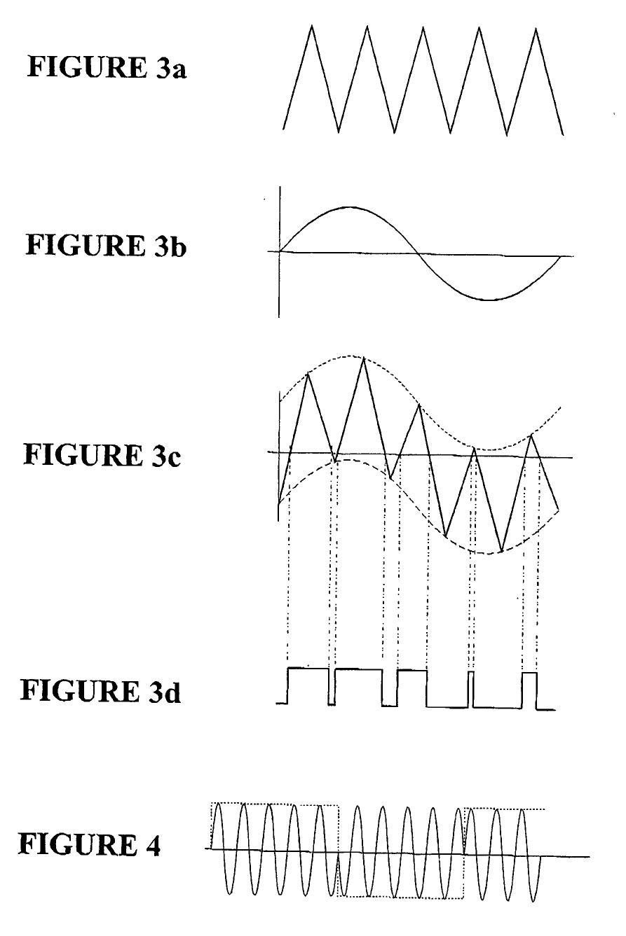

FIG. 3(a) shows a triangular bias signal,

FIG. 3(b) shows a sinusoidal input or message signal,

FIG. 3(c) shows the sum of the bias and input signals,

FIG. 3(d) shows the output of hard limiting the waveform of FIG. 3(c), and

FIG. 4 shows a carrier signal modulated by the waveform of FIG. 3(d).

### DETAILED DESCRIPTION OF THE PREFERRED EMBODIMENTS

FIG. 1 is a simplified block diagram of a transmitter according to the preferred form of the invention and will be explained with reference to the waveform diagrams of FIGS. 3 and 4. Analog information signal A (see FIG. 3(b) is added to a triangular or sinusoidal bias signal B (see FIG. 3(a) produced by bias generator 2, in adder 1. The combined signal C (see FIG. 3(c) is then converted to a square wave D (see FIG. 3(d) by hard limiter 3. The amplitude of the bias is set to be always larger than the information signal. This ensures the bias signal controls the limiting operation. Zero crossings of the output D from the hard limiter 3, although firmly fixed in frequency by that of the bias, vary the zero crossings in order to carry analog information. Timing of the zero crossings therefore carries all of the analog information.

To modulate the RF carrier E produced by RF generator 5, the squarewave D from the hard limiter 3 controls an analog switch 4 to reverse the RF carrier phase randomly with each reversal of the hard limiter square wave D, in accordance with its zero crossings as shown in FIG. 4. The analog switch 4 therefore provides 0 degree and 180 degree outputs of the RF carrier on direct command by hard limiter 3. These carrier reversals provide the desired ABPM carrier signal output F from the transmitter. Because this bi-phase switching operation is a balanced operation, the RF carrier signal does not appear in the transmitted signal—all of the power is vested in the information sidebands. Because the RF carrier is suppressed by balancing, well-known methods can be used to reconstitute the RP carrier at the receiver as will be described.

FIG. 2 shows a simplified block diagram of a receiver for demodulating received ABPM signals in accordance with a preferred form of the invention. The RF carrier is reconstituted by rectifying the signal G to produce a second harmonic I. This second harmonic I is then detected by means of a phase locked loop 8, acting as a narrow band filter. Next, the signal is divided by 2:1 scaler 9, to reproduce the original carrier signal K. This technology is conventionally used to regenerate the carrier signal in the case of simple BPM.

The input signal G to the receiver is hard limited by limiter 6. The limited signal H is then doubled by frequency doubler 7 to produce a strong second harmonic carrier signal I. A narrow bandwidth Phase Locked Loop (PLL) 8 detects the signal, followed by a 2:1 scaling operation performed by divide by 2 circuit 9 to recover the RF carrier. A 90-degree phase shifted signal L then detects the signal H in multiplier 11. The output M of the multiplier detector is a composite waveform of information and bias signals (see FIG. 3(c). Following the final detector, a final filter 12 rejects the bias signal, restoring the information signal to its proper form (see FIG. 3(b) at receiver output O.

When the signal is finally detected through the carrier recovery operation, there is an inherent ambiguity. This is due to the 2:1 scaling factor. In other words the signal is detected, but it may be “upside-down”. This is not a problem for voice, since “upside-down” voice sounds exactly like ordinary voice. However, for other operations (such as TV for example), where correct resolution of this ambiguity is important, known differential signal processing techniques can be used to alleviate this problem and return the signal to its proper order.

Although somewhat similar to Frequency Modulation (FM) and Phase Modulation (PM), this new method of communication considerably improves signal quality, and it does not require significant increase in the bandwidth of the signal, as in the case of Angle Modulation (FM or PM). By this improved method, equal or better than FM performance can be obtained without increased bandwidth. The method is also very useful in extending the detection range of analog signals. The method is also directly applicable to digital radio, and to digital recording.

Analog Bi-Phase Modulation (ABFM) is the method described in his invention, but ABPM can also be used for transmitting multi-level signals because in the case of ABPM, the timing of zero crossings is determined by the modulation alone. Previous methods such as BBPM, FM and PM also use simple, low-cost, fully saturated transmitters. Since noise is an amplitude phenomenon, Amplitude Modulation (AM) is subject to more noise compared to these other methods. ABPM provides linear transmission simply by varying the zero crossings of the signal. ABPM enjoys significant advantages through use of a saturated transmitter. Further advantages include linear transmission and excellent noise rejection.

Other advantages of ABPM include the following. Breakdown of FM at low signal levels produces a particularly irritating noise called “clicks”, or impulse noise generated by the detection device when it detects sudden signal reversals. Clicks do not occur in an ABPM system because the detection system is totally different. The improved system uses coherent detection, and can even be followed by a second stage of hard limiting after detection, if desired. Optimum ABPM detection methods are identical to that of simple bi-phase modulation, and provide almost identical threshold advantages.

1. A method of modulation for a communications system wherein the transmitted information in the transmission signal is carried in the timing of the phase reversal zero crossings in the transmission signal alone.

2. A communication system wherein the transmitted information in the transmission signal is carried in the timing of the phase reversal zero crossings in the transmission signal alone.

3. A method of modulation for a transmission system comprising the steps of:
receiving an information signal;
adding a bias signal to said information signal to produce a composite signal;
hard limiting the composite signal to produce a square wave;
generating a carrier signal;
reversing the phase of said carrier signal in correspondence with the change in polarities of said square wave; and
transmitting the signal produced by said phase reversal of said carrier signal.

4. A method of modulation according to claim 3 wherein said bias signal is a triangle waveform having a fundamental frequency which is higher than the highest frequency of said information signal.

5. A modulator for a transmission system comprising:
an input for receiving an information signal;
a bias signal generator;
an adder circuit for adding said bias signal to said information signal to produce a composite signal;
a hard limiter which receives said composite signal to produce a square wave output;
a carrier signal generator;
an analog switch which receives said carrier signal and which is switched by the square wave output of said hard limiter;
said analog switch reversing the phase of said carrier signal in correspondence with the change in polarities of said square wave; and
an output means which receives the signal produced by said analog switch.

6. A modulator according to claim 5 wherein said bias signal generator is a triangle wave generator and the bias signal generator fundamental frequency is higher than the highest frequency of said information signal.

7. A modulator according to claim 5 wherein said analog switch is a balanced circuit which thereby suppresses the carrier signal to output only the said bands produced by the action of the analog switch.

8. A demodulator for demodulating transmitted signals having a suppressed carrier wherein the transmitted information is carried in the timing of phase reversal zero crossings in the transmitted signal comprising:
a hard limiter which receives said transmitted signals at its input;
a multiplier which receives the output of said hard limiter at one input;
means for reconstituting said suppressed carrier from the output of said hard limiter;
the output of said means for reconstituting being supplied to the second input of said multiplier; and
a low pass filter connected to the output of said multiplier;
the information signal being available at the output of said low pass filter.

9. A method of demodulation for suppressed carrier signals wherein the transmitted information in said signals is carried in the timing of the phase reversal zero crossings in said signals comprising the steps of:
hard limiting the said signal;
reconstituting said suppressed carrier;
shifting the phase of said reconstituted carrier by 90°;
multiplying the hard limited signal with the phase shifted reconstituted carrier and low pass filtering the output of said multiplier to provide the information signal.
